(19) United States
(12) Patent Application Publication
(10) Pub. No.: US 2026/0333430 A1
(43) Pub. Date: Oct. 22, 2026

(54) SENSING MEASUREMENT METHOD, AND ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/120,372

(22) PCT Filed: Oct. 12, 2022
(86) PCT No.: PCT/CN2022/124941

§ 371 Date: Apr. 11, 2025

(51) Int. Cl. H04W 74/0816; H04L 27/26; H04W 84/12

(52) U.S. Cl. CPC H04W 74/0816; H04L 27/2613; H04W 84/12

(57) ABSTRACT

A sensing measurement method is performed by a station device, and includes: transmitting a first null data packet announcement (NDPA) frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device; and instructing an access point device to transmit a last sensing measurement result during the sensing measurement setup process.

### CROSS REFERENCE TO RELATED APPLICATIONS

This application is a National Phase of International Application No. PCT/CN2022/124941, filed on Oct. 12, 2022, the entire contents of which are incorporated herein by reference in their entireties.

### TECHNICAL FIELD

The present disclosure relates to the field of communication technologies, and in particular to a sensing measurement method and apparatus, an electronic device, and a storage medium.

### BACKGROUND

With the rapid development of mobile communication technology, a wireless fidelity (Wi-Fi) technology has made tremendous progress in terms of transmission rate as well as throughput. In the currently studied Wi-Fi technology, it may support a wireless local area network (WLAN) sensing technology, for example, application scenarios such as location discovery, proximity detection, and presence detection in a dense environment (such as home and business environments).

The process of WLAN sensing typically includes a trigger-based (TB) sensing mode and a non-TB (NTB) sensing mode. Specifically, the TB sensing mode means that an access point (AP) device is an initiator or a transmitter, and the NTB sensing mode means that a station (STA) device is an initiator or a transmitter. In the NTB sensing measurement, there is a delayed reporting of a measurement result, therefore, there is a need to provide a specific way to realize the delayed reporting in order to improve the NTB sensing measurement signaling procedure to adapt it to the wireless sensing requirements.

### SUMMARY

Embodiments of the present disclosure provide a sensing measurement method and apparatus, an electronic device, and a storage medium, to provide a way to realize the delayed reporting.

According to an aspect of the embodiments of the present disclosure, there is provided a sensing measurement method, performed by a station device, and including:
transmitting a first null data packet announcement (NDPA) frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device; and
instructing an access point device to transmit a last sensing measurement result during the sensing measurement setup process.

According to another aspect of the embodiments of the present disclosure, there is provided a sensing measurement method, performed by an access point device, and including:
receiving a first null data packet announcement (NDPA) frame carrying a first sensing measurement parameter of a first null data packet (NDP) frame, where at least one parameter in the first sensing measurement parameter is a minimum value among sensing measurement parameters supported by a station device, and/or at least one parameter in the first sensing measurement parameter is smaller than sensing measurement parameters of other sensing measurement instances during a sensing measurement setup process of the station device; and
transmitting a last sensing measurement result during the sensing measurement setup process.

The embodiments of the present disclosure further provide an electronic device, including a processor, and a memory storing computer programs executable by the processor, where the computer programs, when executed by the processor, cause the processor to perform any of the methods in the embodiments of the present disclosure.

The embodiments of the present disclosure further provide a non-transitory computer-readable storage medium, storing computer programs thereon, where the computer programs, when executed by a processor, cause the processor to perform any of the methods in the embodiments of the present disclosure.

Additional aspects and advantages of the embodiments of the present disclosure will be described, in part, in the following description, and these will become apparent from the following description or learned through the implementation of the present disclosure.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without inventive efforts.

FIG. 1 is a flowchart illustrating a sensing measurement method according to an embodiment of the present disclosure.

FIG. 2 is a schematic diagram of a first example of an embodiment of the present disclosure.

FIG. 3 is another schematic diagram of the first example of the embodiment of the present disclosure.

FIG. 4 is yet another schematic diagram of the first example of the embodiment of the present disclosure.

FIG. 5 is a schematic diagram of a second example of an embodiment of the present disclosure.

FIG. 6 is a schematic diagram of a third example of an embodiment of the present disclosure.

FIG. 7 is a flowchart illustrating a sensing measurement method according to another embodiment of the present disclosure.

FIG. 8 is a schematic structural diagram illustrating an electronic device according to an embodiment of the present disclosure.

FIG. 9 is a schematic structural diagram illustrating an electronic device according to another embodiment of the present disclosure.

FIG. 10 is a schematic structural diagram illustrating an electronic device according to yet another embodiment of the present disclosure.

### DETAILED DESCRIPTION OF THE EMBODIMENTS

The wording “and/or” in the present disclosure describes an association relationship of an associated object, and indicates that three relationships may exist, e.g., A and/or B, which may be expressed as: A alone, both A and B, and B alone. The character “/” generally indicates an “or” relationship between the related objects.

The wording “plurality” in the present disclosure means two or more, and other quantifiers are similar.

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terminology used herein is for the purpose of describing particular embodiments only and is not intended to be limiting of the present disclosure. As used herein, the singular forms “a”, “said” and “the” are intended to include the plural forms as well, unless the context clearly indicates otherwise. It will also be understood that as used herein, the term “and/or” is and includes any or all combinations of one or more of the associated listed items.

It will be understood that while terms such as “first”, “second”, “third”, etc. may be used to describe to describe various information, such information should not be limited to these terms. These terms are used only to distinguish the same type of information from each other. For example, without departing from the scope of the present disclosure, a first information may also be referred to as a second information, and similarly, a second information may also be referred to as a first information. Depending on the context, as used herein, the wording “if” may be interpreted as “while . . . ” or “when . . . ” or “in response to a determination”.

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

Embodiments of the present disclosure provide a sensing measurement method and apparatus, an electronic device, and a storage medium, to provide a way to realize the delayed reporting.

The method and the apparatus are based on the same conception, and since the method and the apparatus solve problems on similar principles, the implementations of the apparatus and the method can be referred to each other, and the repetitions will not be repeated.

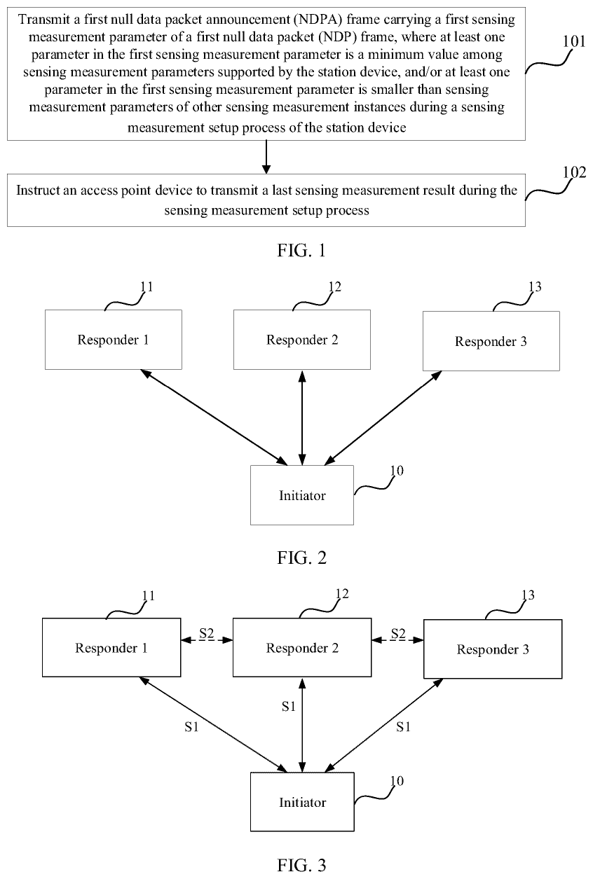

An embodiment of the present disclosure provides a sensing measurement method, which is performed by a station device, and as shown in FIG. 1, the method sensing measurement method may include the following steps 101 to 102.

At step 101, a first null data packet announcement (NDPA) frame which carries a first sensing measurement parameter of a first null data packet (NDP) frame is transmitted, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device.

As a first example, referring to FIGS. 2 to 4, firstly, the architecture for WLAN sensing and the process of WLAN sensing of the sensing measurement provided by the embodiment of the present disclosure are introduced.

FIG. 2 shows a schematic diagram of an architectural for WLAN sensing. A sensing initiator 10 (or an initiator) initiates the WLAN sensing (for example, initiating WLAN sensing session), and there may be a plurality of sensing responders (or sensing receivers, or responders) responding to the sensing initiator, for example, a responder 1, 11, a responder 2, 12 and a responder 3, 13 as shown in FIG. 2. When the sensing initiator initiates the WLAN sensing, the plurality of sensing responders for associated or unassociated WLAN sensing may respond.

Referring to FIG. 3, the sensing initiator and the sensing responder communicate through a communication connection, as shown a communication connection S1. The sensing responders communicate with each other through a communication connection S2.

A sensing initiator may be a client, and a sensing responder (in this example, the sensing responder 1 to the sensing responder 3) may be a station (STA) device or an access point (AP) device. In addition, a STA and an AP can assume multiple roles in the process of WLAN sensing. For example, in the process of WLAN sensing, the STA can also serve as a sensing initiator, which may be a sensing transmitter, a sensing receiver, or both, or neither. In the process of WLAN sensing, the sensing responder may also be a sensing transmitter, a sensing receiver, or both.

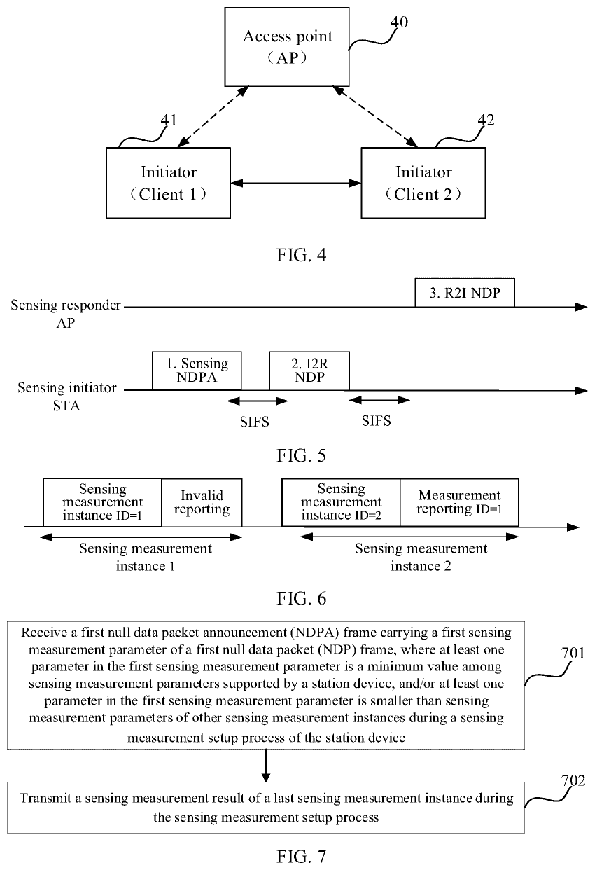

As another architecture, as shown in FIG. 4, the sensing initiator and the sensing responder can also be both clients, and they can communicate with each other by connecting to the same access point (AP) 40 device. In FIG. 4, a client 1 41 is a sensing initiator, and a client 2 42 is a sensing responder.

Typically, the process of WLAN sensing typically includes a trigger-based (TB) sensing mode and a non-TB (NTB) sensing mode. Specifically, the TB sensing mode means that an access point (AP) device is an initiator or a transmitter, and the NTB sensing mode means that a station (STA) device is an initiator or a transmitter. As a second example, as shown in FIG. 5, in the NTB sensing measurement process, a SIFS denotes a short inter frame space. Referring to FIG. 5, the sensing initiator (for example, the STA) first performs step 1 to transmit a sensing NDPA frame, and then performs step 2 to transmit a sensing initiator to responder (I2R) NDP frame. The sensing responder (for example, the AP) performs step 3 to transmit a sensing responder to initiator (R2I) NDP frame.

In the NTB sensing measurement, there is a situation of the delayed reporting of the measurement result. As a third example, as shown in FIG. 6, when a sensing measurement instance 1 is completed, the AP transmits an invalid reporting; when a sensing measurement instance 2 is completed, the AP transmits the sensing measurement reporting of the sensing measurement instance 1 (i.e., a measurement reporting ID=1), and so on to form the delayed reporting of the measurement result.

In the embodiments of the present disclosure, before the last sensing measurement result is transmitted, the STA transmits the first NDPA frame which carries the first sensing measurement parameter of the first NDP frame, so that the AP subsequently performs, based on the first sensing measurement parameter, an NDPA sensing measurement. In some embodiments, the sensing measurement parameters includes at least one of: a band width (BW) parameter or a spatial stream (SS) quantity parameter.

At least one parameter in the first sensing measurement parameter is a minimum value among sensing measurement parameters supported by the station device, and/or at least one parameter in the first sensing measurement parameter is smaller than sensing measurement parameters of previous other sensing measurement instances during a sensing measurement setup process of the station device. That is, at least one parameter in the first sensing measurement parameter configured for the subsequent upcoming sensing measurement in the NDPA sensing measurement before the last sensing measurement result is sent is a minimum value, and/or at least one of the parameters is smaller than the values of the sensing measurement parameters of the previous sensing measurement instances.

In the embodiments of the present disclosure, the other sensing measurement instances are the sensing measurement instances prior to the last sensing measurement instance.

For example, the first sensing measurement parameter includes at least one of that:
the BW in the first sensing measurement parameter is 20 MHz;
the SS in the first sensing measurement parameter is equal to 1, where SS=1, which can be mapped to obtain a number of long training field (LTF) equal to 1, and in some embodiments, the LTF is a high efficiency (HE) LTF;
the BW in the first sensing measurement parameter is smaller than the BW in the previous sensing measurement instances; or
the SS in the first sensing measurement parameter is smaller than the SS in the previous sensing measurement instances.

In some embodiments, the number of LTF in the first NDP frame is 1.

The last sensing measurement parameter is smaller than the sensing measurement parameters of other sensing measurement instances during the sensing measurement setup (MS) process, such that the network resources and the power of the device are saved.

In some embodiments, the first NDP frame may include a I2R NDP frame and/or a R2I NDP frame, as shown in FIG. 5.

At step 102, an access point device is instructed to transmit a last sensing measurement result during the sensing measurement setup process.

After configuring the sensing measurement parameters for the NDP frame, the STA can instruct the AP to report the last uplink sensing measurement result after the SIFS. For example, if n sensing measurements are performed, the last sensing measurement result is the sensing measurement result of the n-1 sensing measurement instance.

If the AP wants to transmit the measurement report of the last measurement instance, in order to ensure the integrity of the signaling, an additional sensing measurement is required. For example, during the measurement setup (MS) process, 10 sensing measurement instances are negotiated, in fact, 11 sensing measurements are performed. The 11th sensing measurement instance is used for the delayed reporting of the measurement report of the 10th sensing measurement instance. Since the 11th sensing measurement instance is to ensure the integrity of signaling and to transmit the 10th sensing measurement report, the parameters of the 11th sensing measurement instance may be different from those of the previous 10 sensing measurement instances. For example, the BW in the previous 10 sensing measurements is 80 MHz and the SS in the previous 10 sensing measurements is 4. In order to save the network resources and the power of the device, for the parameters of the 11th sensing measurement, the BW in the 11th sensing measurement is 20 MHz and the SS in the 11th sensing measurement is 1.

In the embodiments of the present disclosure, before the last sensing measurement result is transmitted, the STA transmits the first null data packet announcement (NDPA) frame which carries the first sensing measurement parameter of the first null data packet (NDP) frame, so that the AP subsequently performs, based on the first sensing measurement parameter, an NDPA sensing measurement and transmits, based on the first sensing measurement parameter, a last sensing measurement result. At least one parameter in the first sensing measurement parameter is a minimum value among sensing measurement parameters supported by the station device, and/or at least one parameter in the first sensing measurement parameter is smaller than sensing measurement parameters of previous other sensing measurement instances during a sensing measurement setup process of the station device, such that the network resources and the power of the device are saved.

An embodiment of the present disclosure provides a sensing measurement method, which is performed by a station device, and the method sensing measurement method may include:
transmitting a first null data packet announcement (NDPA) frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device; and
in response to the first sensing measurement parameter including the band width parameter, instructing an access point device to transmit, based on the band width parameter, the last sensing measurement result during the sensing measurement setup process.

For example, the BW in the first sensing measurement parameter is 20 MHz, this indicates that the BW in the last sensing measurement result reported by the AP after the SIFS is 20 MHz. The last sensing measurement parameter is smaller than the sensing measurement parameters of other sensing measurement instances during the sensing measurement setup (MS) process, such that the network resources and the power of the device are saved.

An embodiment of the present disclosure provides a sensing measurement method, which is performed by a station device, and the method sensing measurement method may include:
transmitting a second NDPA frame carrying a second sensing measurement parameter of a second NDP frame, where the second sensing measurement parameter includes the sensing measurement parameters supported by the station device;
transmitting a first null data packet announcement (NDPA) frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than the second measurement parameters, for example, the BW in the first sensing measurement parameter is smaller than the BW in the second sensing measurement parameter, and the SS in the first sensing measurement parameter is smaller than the SS in the second sensing measurement parameter; and
instructing an access point device to transmit, based on the band width parameter, the last sensing measurement result during the sensing measurement setup process.

The second sensing measurement parameter refers to the sensing measurement parameters of other sensing measurement instances during the sensing measurement setup process. The second sensing measurement parameter can be sensing measurement parameters supported by the station device, such as the BW is 20 MHz, 40 MHz, 80 MHz, 160 MHz, etc., and the SS is 1, 2, 3, 4, etc. The first sensing measurement parameter or at least one parameter of the last sensing measurement instance is the minimum value or smaller than the corresponding parameter in the second sensing measurement parameter.

An embodiment of the present disclosure provides a sensing measurement method, which is performed by a station device, and the method sensing measurement method may include:
transmitting a second NDPA frame carrying a second sensing measurement parameter of a second NDP frame, where the second sensing measurement parameter includes the sensing measurement parameters supported by the station device;
instructing the access point device to transmit, based on a band width parameter in the second sensing measurement parameter, sensing measurement results of the other sensing measurement instances during the sensing measurement setup process, where the other sensing measurement instances are sensing measurement instances prior to the last sensing measurement instance;
transmitting a first null data packet announcement (NDPA) frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device; and
instructing an access point device to transmit, based on the band width parameter, the last sensing measurement result during the sensing measurement setup process.

In the embodiments of the present disclosure, before the last sensing measurement result is transmitted, the STA transmits the first null data packet announcement (NDPA) frame which carries the first sensing measurement parameter of the first null data packet (NDP) frame, so that the AP subsequently performs, based on the first sensing measurement parameter, an NDPA sensing measurement and transmits, based on the first sensing measurement parameter, a last sensing measurement result. At least one parameter in the first sensing measurement parameter is a minimum value among sensing measurement parameters supported by the station device, and/or at least one parameter in the first sensing measurement parameter is smaller than sensing measurement parameters of previous other sensing measurement instances during a sensing measurement setup process of the station device, such that the network resources and the power of the device are saved.

An embodiment of the present disclosure provides a sensing measurement method, which is performed by an access point device, and as shown in FIG. 7, the method sensing measurement method may include the following steps 701 to 702.

At step 701, a first null data packet announcement (NDPA) frame which carries a first sensing measurement parameter of a first null data packet (NDP) frame is received, where at least one parameter in the first sensing measurement parameter is a minimum value among sensing measurement parameters supported by a station device, and/or at least one parameter in the first sensing measurement parameter is smaller than sensing measurement parameters of other sensing measurement instances during a sensing measurement setup process of the station device.

The architecture for WLAN sensing and the WLAN sensing process of the sensing measurement method provided in the embodiments of the present disclosure are referred to in the aforementioned first example, the NTB sensing measurement process is referred to in the aforementioned second example, and the process of delayed reporting of the measurement result is referred to in the aforementioned third example, and will not be repeated herein.

In the embodiments of the present disclosure, before the last sensing measurement result is transmitted, the AP receives the first NDPA frame transmitted by the STA, the first NDPA frame carries the first sensing measurement parameter of the first NDP frame, and the AP performs, based on the first sensing measurement parameter, an NDPA sensing measurement. In some embodiments, the sensing measurement parameters include at least one of: a band width (BW) parameter or a spatial stream (SS) quantity parameter.

At least one parameter in the first sensing measurement parameter is a minimum value among sensing measurement parameters supported by the station device, and/or at least one parameter in the first sensing measurement parameter is smaller than sensing measurement parameters of previous other sensing measurement instances during a sensing measurement setup process of the station device. That is, at least one parameter in the first sensing measurement parameter configured for the subsequent upcoming sensing measurement in the NDPA sensing measurement before the last sensing measurement result is sent is a minimum value, and/or at least one of the parameters is smaller than the values of the sensing measurement parameters of the previous sensing measurement instances.

In the embodiments of the present disclosure, the other sensing measurement instances are the sensing measurement instances prior to the last sensing measurement instance.

For example, the first sensing measurement parameter includes at least one of:
the BW in the first sensing measurement parameter is 20 MHz;
the SS in the first sensing measurement parameter is equal to 1;
the BW in the first sensing measurement parameter is smaller than the BW in the previous sensing measurement instances; or
the SS in the first sensing measurement parameter is smaller than the SS in the previous sensing measurement instances.

In some embodiments, the number of LTF in the first NDP frame is 1.

The last sensing measurement parameter is smaller than the sensing measurement parameters of other sensing measurement instances during the sensing measurement setup process, such that the network resources and the power of the device are saved.

In some embodiments, the first NDP frame may include a I2R NDP frame and/or a R2I NDP frame, as shown in FIG. 5.

At step 702, a last sensing measurement result during the sensing measurement setup process is transmitted.

The AP reports the last uplink sensing measurement result after the SIFS. For example, if n sensing measurements are performed, the last sensing measurement result is the sensing measurement result of the n-1 sensing measurement instance.

If the AP wants to transmit the measurement report of the last measurement instance, in order to ensure the integrity of the signaling, an additional sensing measurement is required. For example, during the measurement setup (MS) process, 10 sensing measurement instances are negotiated, in fact, 11 sensing measurements are performed. The 11th sensing measurement instance is used for the delayed reporting of the measurement report of the 10th sensing measurement instance. Since the 11th sensing measurement instance is to ensure the integrity of signaling and to transmit the 10th sensing measurement report, the parameters of the 11th sensing measurement instance may be different from those of the previous 10 sensing measurement instances. For example, the BW in the previous 10 sensing measurements is 80 MHz and the SS in the previous 10 sensing measurements is 4. In order to save the network resources and the power of the device, for the parameters of the 11th sensing measurement, the BW in the 11th sensing measurement is 20 MHz and the SS in the 11th sensing measurement is 1.

An embodiment of the present disclosure provides a sensing measurement method, which is performed by an access point device, and the method sensing measurement method may include:
receiving a second NDPA frame carrying a second sensing measurement parameter of a second NDP frame, where the second sensing measurement parameter includes the sensing measurement parameters supported by the station device;
receiving a first null data packet announcement (NDPA) frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than the second measurement parameters, for example, the BW in the first sensing measurement parameter is smaller than the BW in the second sensing measurement parameter, and the SS in the first sensing measurement parameter is smaller than the SS in the second sensing measurement parameter; and
transmitting a last sensing measurement result during the sensing measurement setup process.

The second sensing measurement parameter refers to the sensing measurement parameters of other sensing measurement instances during the sensing measurement setup process. The second sensing measurement parameter can be sensing measurement parameters supported by the station device, such as the BW is 20 MHz, 40 MHz, 80 MHz, 160 MHz, etc., and the SS is 1, 2, 3, 4, etc. The first sensing measurement parameter or at least one parameter of the last sensing measurement instance is the minimum value or smaller than the corresponding parameter in the second sensing measurement parameter.

In the embodiments of the present disclosure, before the last sensing measurement result is transmitted, the AP receives the first null data packet announcement (NDPA) frame, and obtains the first sensing measurement parameter carried in the NDPA frame. The AP performs, based on the first sensing measurement parameter, an NDPA sensing measurement and transmits, based on the first sensing measurement parameter, a last sensing measurement result. At least one parameter in the first sensing measurement parameter is a minimum value among sensing measurement parameters supported by the station device, and/or at least one parameter in the first sensing measurement parameter is smaller than sensing measurement parameters of previous other sensing measurement instances during a sensing measurement setup process of the station device, such that the network resources and the power of the device are saved.

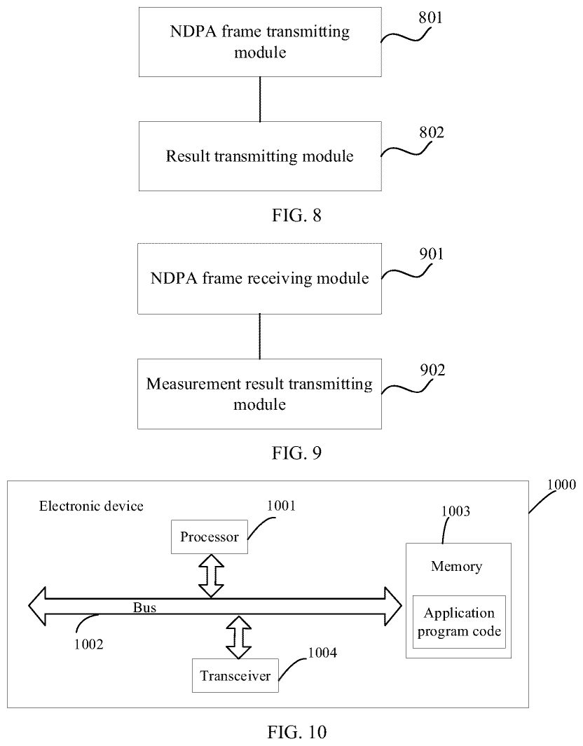

Referring to FIG. 8, based on the same principle as the method provided in the embodiments of the present disclosure, the embodiments of the present disclosure also provides an electronic device serving as a station device. The electronic device includes a NDPA frame transmitting module 801 and a result transmitting module 802.

The NDPA frame transmitting module 801 is configured to transmit a first NDPA frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device.

The result transmitting module 802 is configured to instruct an access point device to transmit a last sensing measurement result during the sensing measurement setup process.

In some embodiments, the sensing measurement parameters include at least one of: a band width (BW) parameter or a parameter for number of spatial streams (SS).

In some embodiments, the result transmitting module 802 is configured to: in response to the first sensing measurement parameter including the band width parameter, instructing an access point device to transmit, based on the band width parameter, the last sensing measurement result during the sensing measurement setup process.

In some embodiments, the number of LTF in the first NDP frame is 1.

In some embodiments, the electronic device may also include a second transmitting module.

The second transmitting module is configured to, before the NDPA frame transmitting module 801 transmits the first NDPA frame, transmit a second NDPA frame carrying a second sensing measurement parameter of a second NDP frame, where the second sensing measurement parameter includes the sensing measurement parameters supported by the station device.

In some embodiments, the electronic device may also include a second instructing module.

The second instructing module is configured to, after the second transmitting module transmits the second NDPA frame, instruct the access point device to transmit, based on a band width parameter in the second sensing measurement parameter, sensing measurement results of the other sensing measurement instances during the sensing measurement setup process.

An embodiment of the present disclosure provides a sensing measurement apparatus, applied to a station device, and including: a NDPA frame transmitting module and a instruction transmitting module.

The NDPA frame transmitting module is configured to transmit a first NDPA frame carrying a first sensing measurement parameter of a first null data packet (NDP) frame, where at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device.

The instruction transmitting module is configured to instruct an access point device to transmit a last sensing measurement result during the sensing measurement setup process.

The apparatus also includes other modules of the electronic device in the foregoing embodiments, which will not be repeated herein.

Referring to FIG. 9, based on the same principle as the method provided in the embodiments of the present disclosure, the embodiments of the present disclosure also provide an electronic device serving as an access point device. The electronic device includes a NDPA frame receiving module 901 and a measurement result transmitting module 902.

The NDPA frame receiving module 901 is configured to receive a first NDPA frame carrying a first sensing measurement parameter of a first null data packet (NDP) frame, where at least one parameter in the first sensing measurement parameter is a minimum value among sensing measurement parameters supported by a station device, and/or at least one parameter in the first sensing measurement parameter is smaller than sensing measurement parameters of other sensing measurement instances during a sensing measurement setup process of the station device.

The measurement result transmitting module 902 is configured to transmit a last sensing measurement result during the sensing measurement setup process.

In some embodiments, the sensing measurement parameters include at least one of: a band width (BW) parameter or a parameter for number of spatial streams (SS).

In some embodiments, the number of LTF in the first NDP frame is 1.

In some embodiments, the electronic device may also include a second receiving module.

The second receiving module is configured to, before the NDPA frame receiving module receives the first NDPA frame, receive a second NDPA frame carrying a second sensing measurement parameter of a second NDP frame, where the second sensing measurement parameter includes the sensing measurement parameters supported by the station device.

An embodiment of the present disclosure provides a sensing measurement apparatus, applied to an access point device, and including: a NDPA frame receiving module and a measurement result transmitting module.

The NDPA frame receiving module is configured to receive a first NDPA frame carrying a first sensing measurement parameter of a first null data packet (NDP) frame, where at least one parameter in the first sensing measurement parameter is a minimum value among sensing measurement parameters supported by a station device, and/or at least one parameter in the first sensing measurement parameter is smaller than sensing measurement parameters of other sensing measurement instances during a sensing measurement setup process of the station device.

The measurement result transmitting module is configured to transmit a last sensing measurement result during the sensing measurement setup process.

The apparatus also includes other modules of the electronic device in the foregoing embodiments, which will not be repeated herein.

The embodiments of the present disclosure also provide an electronic device, as shown in FIG. 10, the electronic device 1000 may be a server including: a processor 1001 and a memory 1003. The processor 1001 and the memory 1003 are connected, e.g., via a bus 1002. In some embodiment, the electronic device 1000 may also include a transceiver 1004. It will be noted that the transceiver 1004 is not limited to one in number in practical applications, and the structure of the electronic device 1000 does not constitute a limitation of the embodiments of the present disclosure.

The processor 1001 may be a central processing unit (CPU), a general purpose processor, a digital signal processor (DSP), an application specific integrated circuit (ASIC), a field programmable gate array (FPGA) or other programmable logic device, a transistor logic device, a hardware component or any combination thereof. It can implement or execute various exemplary logical blocks, modules, and circuits described in conjunction with the present disclosure. The processor 1001 may also be a combination for realizing computing functions, for example, including a combination of one or more microprocessor, a combination of digital signal processor (DSP) and microprocessor, etc.

The bus 1002 may include a pathway to transfer information between the foregoing components. The bus 1002 may be a peripheral component interconnect (PCI) bus or an extended industry standard architecture (EISA) bus, and so on. The bus 1002 may include an address bus, a data bus, a control bus, and so on. For ease of representation, only a thick line is shown in FIG. 10, but it does not mean that there is only one bus or one type of bus.

The memory 1003 may be a read only memory (ROM) or other type of static storage device that can store static information and instructions, a random access memory (RAM) or other type of dynamic storage device that can store information and instructions. It can also be an electrically erasable programmable read only memory (EEPROM), a compact disc read only memory (CD-ROM), CD-ROM) or other optical storage (including a compact disc, a laser disc, an optical disc, a digital versatile disc, a Blu-ray disc, etc.), magnetic storage medium or other magnetic storage devices, or any other medium that can be used to carry or store desired program codes in the form of instructions or data structures and can be accessed by a computer, but is not limited thereto.

The memory 1003 is configured to store the application program code for executing the scheme of the present disclosure and is controlled for execution by processor 1001. The processor 1001 is configured to execute the application program code stored in the memory 1003 to implement the foregoing method embodiments.

The electronic device includes, but is not limited to, a mobile terminal such as a cell phone, a laptop computer, a digital broadcast receiver, a personal digital assistant (PDA), a portable android device (PAD), a portable multimedia player (PMP), an on-board terminal (such as an on-board navigation terminal), as well as a stationary terminal (such as a digital TV, a desktop computer), and the like. The electronic device shown in FIG. 10 is only an example, and will not limit to the functions and use scope of the embodiments of the present disclosure.

The server provided by the present disclosure may be an independent physical server, a server cluster or distributed system including a plurality of physical servers, and a cloud server providing basic cloud computing services such as cloud services, cloud databases, cloud computing, cloud functions, cloud storage, network services, cloud communications, middleware services, domain name services, security services, CDNs, and big data and artificial intelligence platforms. The terminal can be a smartphone, tablet, laptop, desktop computer, smart speaker, smartwatch, etc., but is not limited to these. The terminal and the server can be directly or indirectly connected through wired or wireless communication, and the present disclosure is not limited herein.

Embodiments of the present disclosure provide a non-transitory computer-readable storage medium having computer programs stored thereon, which, when run on a computer, cause the computer to execute the corresponding contents of the foregoing method embodiments.

In the embodiments of the present disclosure, before the last sensing measurement result is transmitted, the STA transmits the first null data packet announcement (NDPA) frame which carries the first sensing measurement parameter of the first null data packet (NDP) frame, so that the AP subsequently performs, based on the first sensing measurement parameter, an NDPA sensing measurement and transmits, based on the first sensing measurement parameter, a last sensing measurement result. At least one parameter in the first sensing measurement parameter is a minimum value among sensing measurement parameters supported by the station device, and/or at least one parameter in the first sensing measurement parameter is smaller than sensing measurement parameters of previous other sensing measurement instances during a sensing measurement setup process of the station device, such that the network resources and the power of the device are saved.

It will be understood that although the individual steps in the flowchart of the accompanying drawings are shown sequentially as indicated by arrows, the steps are not necessarily executed sequentially in the order indicated by the arrows. Unless expressly stated herein, there is no strict order limitation on the execution of these steps, which may be executed in some other order. At least a portion of the steps in the flowchart of the accompanying drawings may include a plurality of sub-steps or a plurality of phases, the sub-steps or phases are not necessarily executed to completion at the same moment but may be executed at different moments, and the order of execution thereof is not necessarily sequential, but may be executed in turn or in alternation with at least a portion of the other steps or sub-steps or phases of the other steps.

It will be noted that the computer-readable medium shown in the present disclosure may be a computer readable signal medium or a computer readable storage medium or any combination thereof. The computer-readable storage medium may be, but is not limited to, an electrical, magnetic, optical, electromagnetic, infrared, or semiconductor system, apparatus, or component, or any combination thereof. More specific examples of the computer readable storage medium may include, but are not limited to: an electrical connection having one or more wires, a portable computer disk, a hard disk, a random access memory (RAM), a read-only memory (ROM), an erasable programmable read only memory (EPROM or a flash memory), an optical fiber, a portable compact disk read-only memory (CD-ROM), an optical storage device, a magnetic storage device, or any suitable combination thereof. In the present disclosure, the computer readable storage medium may be any tangible medium including or storing a program, and the program may be used by or in combination with an instruction execution system, apparatus, or device. In the present disclosure, the computer readable signal medium may be a data signal included in a baseband or propagated as a part of a carrier, in which computer readable program code is carried. This propagated data signal can take many forms, including but not limited to electromagnetic signals, optical signals, or any suitable combination thereof. The computer-readable signal medium may also be any computer-readable medium other than a computer-readable storage medium, and the computer-readable medium may send, propagate, or transmit a program for use by or in combination with an instruction execution system, an apparatus, or a component. The program code contained on the computer-readable medium may be transmitted using any appropriate medium, including but not limited to: wireless, wire, optical cable, RF, etc., or any suitable combination of the foregoing.

The computer-readable medium may be included in the electronic device; or the computer-readable medium may exist independently without being assembled into the electronic device.

The computer-readable medium carries one or more programs, which, when executed by the electronic device, cause the electronic device to perform the method in the embodiments.

According to an aspect of the present disclosure, there is provided a computer program product or computer program including computer instructions which are stored in a computer-readable storage medium. The processor of the computer device reads the computer instructions from a computer-readable storage medium, executes the computer instructions, and causes the computer device to perform the methods provided in the various optional implementations.

A program code for performing the operation of the present disclosure may be written by using any combination of one or more programming languages. The programming language includes an object-oriented programming language such as Java, C++, and a conventional procedural programming language such as a “C” Language or a similar programming language. The program code may be fully executed on a computer of a user or partially executed on a computer of a user, or may be executed as an independent software package, or may be partially executed on a computer of a user and partially executed on a remote computer, or may be fully executed on a remote computer or a server. In case of the remote computer, the remote computer may be connected to the computing device of a user by using any network including a local area network (LAN) or a wide area network (WAN), or may be connected to an external computer (for example, connected to the external computer through the Internet by using an Internet service provider).

Flowcharts and block diagrams in the drawings illustrate architectures, functions, and operations that may be implemented by using the system, the method, and the computer program product according to the various embodiments of the present disclosure. In this regard, each block in the flowchart or the block diagram may represent a module, a program segment, or a part of code. The module, the program segment, or the part of the code includes one or more executable instructions for implementing a specified logical function. It will also be noted that, in some alternative implementations, the functions noted in the blocks may occur in an order different from that noted in the drawings. For example, two blocks shown in succession can actually be executed in parallel, and sometimes they can also be executed in a reverse order, depending on the functions involved. It should also be noted that each block in the block diagrams and/or flowcharts, and combinations of blocks in the block diagrams and/or flowcharts, can be implemented with dedicated hardware-based systems that perform specified functions or operations, or a combination of dedicated hardware and computer instructions.

The modules described in the embodiments of the present disclosure may be implemented in software or hardware. A name of a module does not constitute a limitation on the module itself in some cases. For example, a module A can also be described as a “module A used to perform an operation B”.

The above description is only some embodiments of the present disclosure and an explanation of the applied technical principles. Those skilled in the art should understand that the scope of the invention involved in the present disclosure is not limited to a technical solution formed by a specific combination of the above technical features, but should also cover other technical solutions formed by any combination of the above technical features or their equivalents without departing from the inventive concept of the present disclosure. For example, technical solutions formed by replacing the above features with the technical features having similar functions disclosed in (but not limited to) the present disclosure.

1. A sensing measurement method, performed by a station device, and comprising:
transmitting a first null data packet announcement (NDPA) frame carrying a first sensing measurement parameter of a first null data packet (NDP) frame, wherein at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device; and
instructing an access point device to transmit a last sensing measurement result during the sensing measurement setup process.

2. The sensing measurement method of claim 1, wherein the sensing measurement parameters comprise at least one of: a band width parameter, or a parameter for number of spatial streams.

3. The sensing measurement method of claim 2, wherein the first sensing measurement parameter comprises the band width parameter, and
wherein instructing the access point device to transmit the last sensing measurement result during the sensing measurement setup process comprises:
instructing the access point device to transmit, based on the band width parameter, the last sensing measurement result during the sensing measurement setup process.

4. The sensing measurement method of claim 1, wherein a number of long training field (LTF) of the first NDP frame is 1.

5. The sensing measurement method of claim 1, further comprising:
transmitting a second NDPA frame carrying a second sensing measurement parameter of a second NDP frame, wherein the second sensing measurement parameter comprises the sensing measurement parameters supported by the station device.

6. The sensing measurement method of claim 5, further comprising, after transmitting a second NDPA frame:
instructing the access point device to transmit, based on a band width parameter in the second sensing measurement parameter, sensing measurement results of the other sensing measurement instances during the sensing measurement setup process.

7. A sensing measurement method, performed by an access point device, and comprising:
receiving a first null data packet announcement (NDPA) frame carrying a first sensing measurement parameter of a first null data packet (NDP) frame, wherein at least one parameter in the first sensing measurement parameter is a minimum value among sensing measurement parameters supported by a station device, and/or at least one parameter in the first sensing measurement parameter is smaller than sensing measurement parameters of other sensing measurement instances during a sensing measurement setup process of the station device; and
transmitting a last sensing measurement result during the sensing measurement setup process.

8. The sensing measurement method of claim 7, wherein the sensing measurement parameters comprise at least one of: a band width parameter, or a parameter for number of spatial streams.

9. The sensing measurement method of claim 7, wherein a number of long training field (LTF) of the first NDP frame is 1.

10. The sensing measurement method of claim 7, further comprising:
receiving a second NDPA frame carrying a second sensing measurement parameter of a second NDP frame, wherein the second sensing measurement parameter comprises the sensing measurement parameters supported by the station device.

11. (canceled)

12. (canceled)

13. An electronic device, comprising a processor; and a memory storing computer programs executable by the processor; wherein the computer programs, when executed by the processor, cause the processor to perform operations comprising:
transmitting a first null data packet announcement (NDPA) frame carrying a first sensing measurement parameter of a first null data packet (NDP) frame. wherein at least one parameter in the first sensing measurement parameter is a minimum value among sensing measurement parameters supported by the station device, and/or at least one parameter in the first sensing measurement parameter is smaller than sensing measurement parameters of other sensing measurement instances during a sensing measurement setup process of the station device; and
instructing an access point device to transmit a last sensing measurement result during the sensing measurement setup process.

14. A non-transitory computer-readable storage medium, storing computer programs thereon, wherein the computer programs, when executed by a processor, cause the processor to perform the sensing measurement method of claim 1.

15. An electronic device, comprising a processor; and a memory storing computer programs executable by the processor; wherein the computer programs, when executed by the processor, cause the processor to perform the sensing measurement method of claim 7.

16. A non-transitory computer-readable storage medium, storing computer programs thereon, wherein the computer programs, when executed by a processor, cause the processor to perform the sensing measurement method of claim 7.

17. The electronic device of claim 13, wherein the sensing measurement parameters comprise at least one of: a band width parameter, or a parameter for number of spatial streams.

18. The electronic device of claim 17, wherein the first sensing measurement parameter comprises the band width parameter, and
wherein instructing the access point device to transmit the last sensing measurement result during the sensing measurement setup process comprises:
instructing an access point device to transmit, based on the band width parameter, the last sensing measurement result during the sensing measurement setup process.

19. The electronic device of claim 13, wherein a number of long training field (LTF) of the first NDP frame is 1.

20. The electronic device of claim 13, further comprising:
transmitting a second NDPA frame carrying a second sensing measurement parameter of a second NDP frame, wherein the second sensing measurement parameter comprises the sensing measurement parameters supported by the station device.

21. The electronic device of claim 20, further comprising, after transmitting a second NDPA frame:
instructing the access point device to transmit, based on a band width parameter in the second sensing measurement parameter, sensing measurement results of the other sensing measurement instances during the sensing measurement setup process.
